(19) United States
(12) Patent Application Publication
(10) Pub. No.: US 2025/0194708 A1
(43) Pub. Date: Jun. 19, 2025

(54) MOUNTING ARRANGEMENT

(71) Applicant: RFD BEAUFORT LIMITED, Ellesmere Port (GB)

(72) Inventor: Richard GRIFFIN, Prenton (GB)

(21) Appl. No.: 18/847,153

(22) PCT Filed: Mar. 14, 2023
(86) PCT No.: PCT/EP2023/056440

§ 371 Date: Sep. 13, 2024

(30) Foreign Application Priority Data
Mar. 15, 2022 (GB) 2203555.4

(51) Int. Cl. A41D 13/00; A62B 7/14; A62B 9/04; A62B 25/00; B63C 9/11

(52) U.S. Cl. CPC A41D 13/0012; A62B 7/14; A62B 9/04; A62B 25/005; B63C 9/11

(57) ABSTRACT

An aircrew safety equipment mounting arrangement (31) for attachment to an item worn on the body of an aircrew member is disclosed. The mounting arrangement includes a mounting plate (33), a backing plate (52), pivotal attachment means (55) for coupling the mounting plate to the backing plate, and locking means 61 for locking the mounting plate and the backing plate in a closed position. The mounting arrangement is moveable by the pivotal attachment means between the closed position, in which the mounting arrangement is arranged to clamp the item worn on the body of an aircrew member between the mounting plate and the backing plate, and an open position in which the item worn on the body of an aircrew member is released.

### TECHNICAL FIELD

The present invention relates to an aircrew safety equipment mounting arrangement for attachment to an item worn on the body of an aircrew member. The invention further relates to a method of facilitating attachment of aircrew safety equipment to an item worn on the body of an aircrew member.

### BACKGROUND TO THE INVENTION

It is known to attach a CRU (Crew Regulator Unit) to a harness worn by aircrew. The CRU is connected to an on-board oxygen supply within the aircraft and the oxygen supply is then fed to a breathing mask which the aircrew may wear when required. The CRU needs to be mounted onto an aircrew harness such that when the aircrew enter the aircraft and are seated they can connect to the oxygen supply and put on the mask. The CRU attaches to a known mounting arrangement that includes a mounting plate which has tapered channels that a tapered plate on the back of the CRU slides into and then a press button locks the CRU onto the mounting plate. The mounting arrangement further comprises a backing plate. The mounting plate is attached to the aircrew harness by screwing it onto the backing plate.

FIGS. 1, 2 and 3 show such a known mounting arrangement 1. A mounting plate 3 has a front surface 5 to which two generally L-shaped (in cross-section) linear members 7A and 7B are attached. The L-shaped linear members 7A and 7B each form a linear channel 9A and 9B between the front surface 5 and upper parts 11A and 11B of the L-shaped linear members 7A and 7B that lie generally parallel to the front surface 5. The L-shaped linear members 7A and 7B are inclined in opposite directions along the front surface 5 so that the upper ends (as viewed in FIGS. 1 and 2) are further apart from each other than the lower ends (as viewed in FIGS. 1 and 2). The oppositely inclined channels 9A and 9B formed by the L-shaped linear members 7A and 7B are positioned to accommodate a tapered plate on the back of the CRU.

The mounting plate 3 has an internally threaded cylindrical member 13 at each corner, extending from the rear surface of the mounting plate 3

The mounting arrangement 1 further comprises a backing plate 15 having generally the same shape as the mounting plate 3. The backing plate 15 has a circular opening 17 at each corner.

The mounting arrangement 1 is fixed to a harness 19 by positioning the backing plate 15 and mounting plate 3 on opposite sides of the harness 19. A screw 21 is then passed through each circular opening 17 of the backing plate 15 and into the correspondingly positioned internally threaded cylindrical member 13 of the mounting plate 3. The mounting plate 3 is secured to the backing plate 15 by the external screw thread of the screws 21 co-operating with the internal screw tread of the internally threaded cylindrical member 13. This clamps the mounting arrangement 1 to the harness 19.

This known mounting arrangement 1 is time-consuming to fix to the harness 19 and requires the use of a tool (a screwdriver) to attach the screws 21 to the mounting arrangement 1. Further, the screws 21 may get lost when the mounting arrangement 1 is detached from the harness 19.

### SUMMARY OF THE INVENTION

A first aspect of the present invention provides an aircrew safety equipment mounting arrangement for attachment to an item worn on the body of an aircrew member, the mounting arrangement including a mounting plate, a backing plate, pivotal attachment means for coupling the mounting plate to the backing plate, and locking means for locking the mounting plate and the backing plate in a closed position, the mounting arrangement being moveable by the pivotal attachment means between the closed position, in which the mounting arrangement is arranged to clamp the item worn on the body of an aircrew member between the mounting plate and the backing plate, and an open position in which the item worn on the body of an aircrew member is released.

According to some embodiments of the invention, the pivotal attachment means for coupling the mounting plate to the backing plate and the locking means for locking the mounting plate and the backing plate in a closed position enable the mounting arrangement to clamp the item worn on the body of an aircrew member in a simpler operation that the known arrangement described above. Advantageously, the mounting plate and the backing plate may permanently coupled together by the pivotal attachment means, which simplifies storage, inventory management and handling. The mounting arrangement may be clamped to the item worn on the body of an aircrew member simply by pivoting the mounting plate about the pivotal attachment means and locking it against the backing plate, with the item worn on the body of an aircrew member clamped therebetween, by operating the locking means. Advantageously, no screws are required to fix the mounting plate to the backing plate and not tools are required to fix the mounting plate to the backing plate.

The mounting plate may include a mounting plate tubular pivot portion and the backing plate may include a backing plate tubular pivot portion, and the pivotal attachment means may comprise a pivot pin that passes through the mounting plate tubular pivot portion and the backing plate tubular pivot portion to enable relative rotation between the mounting plate and the backing plate around the pivot pin.

The mounting plate tubular pivot portion and the backing plate tubular pivot portion may be positioned during assembly so that their cylindrical bores are aligned, and the pivot pin passes through the aligned cylindrical bores. The pivot pin may be located so that it cannot readily be removed from the aligned cylindrical bores, e.g. by deforming/enlarging the ends of the pivot pin so that it cannot slide along the axis of the cylindrical bores. However, the mounting plate tubular pivot portion and the backing plate may still move relative to one another by rotation around the pivot pin in the cylindrical bores.

The mounting plate may include a mounting plate tubular locking portion and the backing plate may include a backing plate tubular locking portion, and the locking means may comprise a locking pin that passes through the mounting plate tubular locking portion and the backing plate tubular locking portion to prevent rotation between the mounting plate and the backing plate around the pivot pin. For example, the locking pin may prevent rotational movement of the mounting plate tubular locking portion relative the backing plate by mechanically locking the mounting plate tubular locking portion to the backing plate.

The locking means may further comprise a compression spring fitted between the locking pin and tubular locking portion of one of the mounting plate and the backing plate so that the compression spring urges the locking pin into the tubular locking portion of the other of the mounting plate and the backing plate for locking the mounting plate and the backing plate in the closed position. For example, in its rest state the locking pin will engage both the tubular locking portion of both the mounting plate and the backing plate.

The locking pin may be configured to be manually moveable relative to one of the mounting plate and the backing plate so that the locking pin withdraws from the tubular locking portion of the other of the mounting plate and the backing plate to enable the mounting arrangement to move into the open position.

The mounting plate tubular pivot portion and the backing plate tubular pivot portion may at an opposite end of the mounting arrangement to the mounting plate tubular locking portion and the backing plate tubular locking portion.

The mounting plate may include at least one formation configured to mechanically engage aircrew safety equipment to couple the aircrew safety equipment to the item worn on the body of an aircrew member.

The least one formation may comprise two oppositely inclined channels configured to engage a tapered connecting plate of the aircrew safety equipment.

The aircrew safety equipment may comprise a crew regulator unit. The crew regulator unit may be a device configured to supply breathing gas from a supply or store on the aircraft to a mask worn by the aircrew member.

The item worn on the body of the aircrew member may include a strip of material to which the mounting arrangement is to clamped when closed in use. The strip of material may be fabric.

The item worn on the body of the aircrew member may include a part of a harness, lifejacket or a load-carrying garment.

The load-carrying garment may be a MOLLE load-carrying garment comprising at least one row of webbing that is attached to a backing at attachment sections at spaced apart intervals.

A second aspect of the present invention provides a method of facilitating attachment aircrew safety equipment to an item worn on the body of an aircrew member, the method including:
providing a mounting arrangement including a mounting plate, a backing plate, pivotal attachment means for coupling the mounting plate to the backing plate, and locking means for locking the mounting plate and the backing plate in a closed position;
when the mounting arrangement is in an open position, passing the backing plate behind the item worn on the body of the aircrew member;
rotating the mounting plate about the pivotal attachment means to the closed position, in which the mounting arrangement clamps the item worn on the body of an aircrew member between the mounting plate and the backing plate; and
locking the mounting plate to the backing plate in a closed position.

The method may include mechanically attaching the aircrew safety equipment to the mounting arrangement to couple the aircrew safety equipment to the item worn on the body of an aircrew member to thereby locate the aircrew safety equipment on the body of the aircrew member.

The mounting arrangement used in the method may be one as defined in the preceding paragraphs of this Summary.

### BRIEF DESCRIPTION OF THE DRAWINGS

For a better understanding of the present invention embodiments will now be described by way of example, with reference to the accompanying drawings, in which:

FIG. 1 shows a known mounting arrangement attached to a strap;

FIG. 2 shows a front view of a mounting plate of the mounting arrangement of FIG. 1;

FIG. 3 shows a front view of a backing plate of the mounting arrangement of FIG. 1;

FIG. 4 shows a front view of a mounting arrangement in accordance with an embodiment of the invention in a closed position;

FIG. 5 shows a front perspective view of the mounting arrangement of FIG. 4 in a closed position;

FIG. 6 shows a rear view of the mounting arrangement of FIG. 4 in a fully open position;

FIG. 7 a front perspective view of the mounting arrangement of FIG. 4 in a partially open position;

FIG. 8 an exploded perspective front view of the mounting arrangement of FIG. 4 but omitting a front panel of the mounting plate;

FIG. 8A is a cross-section taken along the central axis of the tubular locking part of the mounting plate;

FIG. 9 a perspective front view of a backing plate of the mounting arrangement of FIG. 4;

FIG. 10 a perspective rear view of a mounting plate of the mounting arrangement of FIG. 4;

FIG. 11 is a rear view of a CRU (Crew Regulator Unit) for attachment to the mounting arrangement;

FIG. 12 is a schematic view of a known load-carrying garment in the form of a military jacket including rows of webbing and with loads in the form of an inflatable lifejacket and two equipment packs attached to the garment;

FIG. 13 shows a partial front view of the load-carrying garment of FIG. 12 to which a mounting arrangement in accordance with an embodiment of the invention is mounted in the open position; and

FIG. 14 shows a partial front view of the load-carrying garment of FIG. 12 to which the mounting arrangement of FIG. 13 is mounted in the closed position.

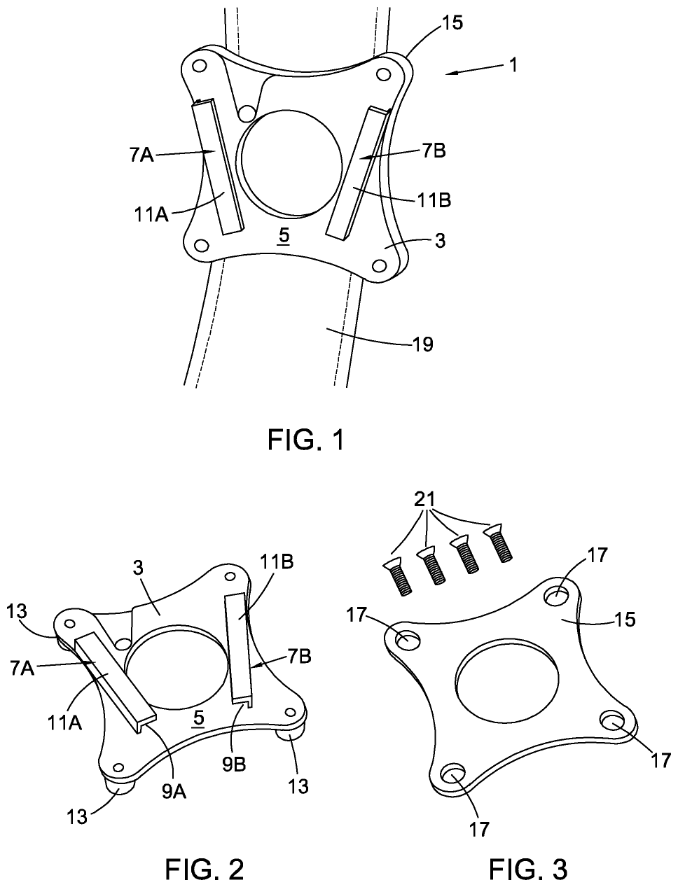

In the drawings, like elements are generally designated with the same reference sign.

### DETAILED DESCRIPTION OF EMBODIMENTS OF THE INVENTION

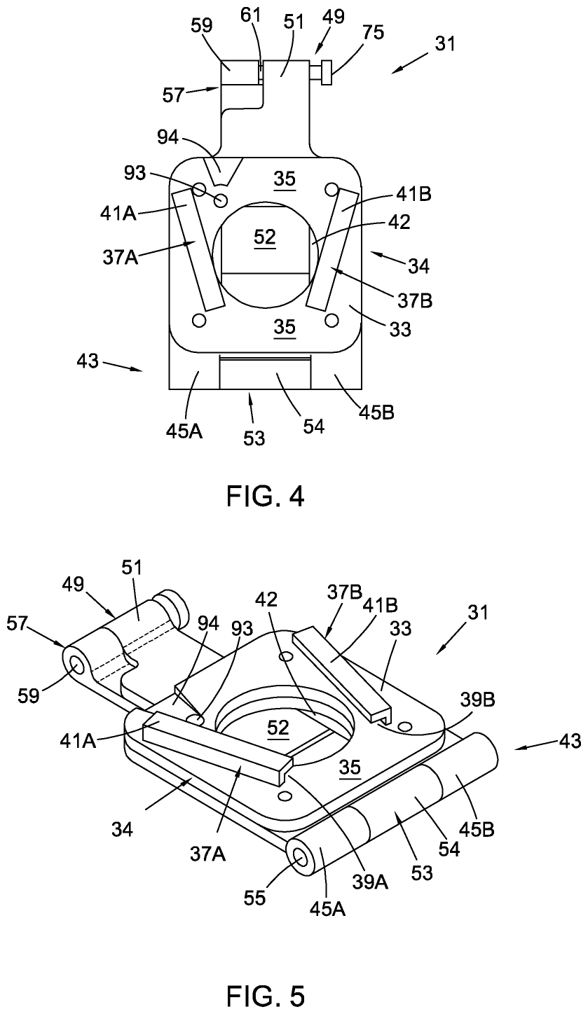

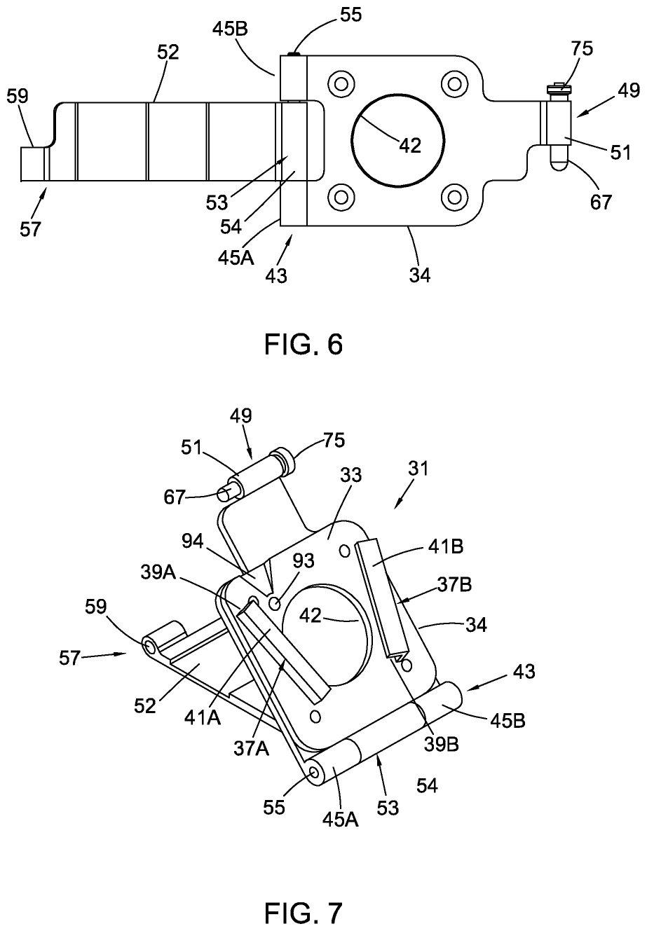

FIGS. 4 to 10 and 13 to 14 show mounting arrangements 31 in accordance with embodiments of the invention.

A mounting plate 33 of a mounting arrangement 31 includes a central area 34 with a main front surface 35 to which two generally L-shaped (in cross-section) linear members 37A and 37B are attached. The L-shaped linear members 37A and 37B each form a linear channel 39A and 39B between the front surface 35 and upper parts 41A and 41B of the L-shaped linear members 37A and 37B that lie generally parallel to the front surface 35. The L-shaped linear members 37A and 37B are symmetrically disposed about a longitudinal central axis of the mounting plate 33. The linear channels 39A and 39B generally face each other

The main front surface 35 may be an integral part of the mounting plate 33. Alternatively, the main front surface 35 may be a separately formed panel (or plate or sheet of material), as shown in the embodiments, and which is attached to the central area 34 of the mounting plate 33 by any suitable means, such as riveting or welding.

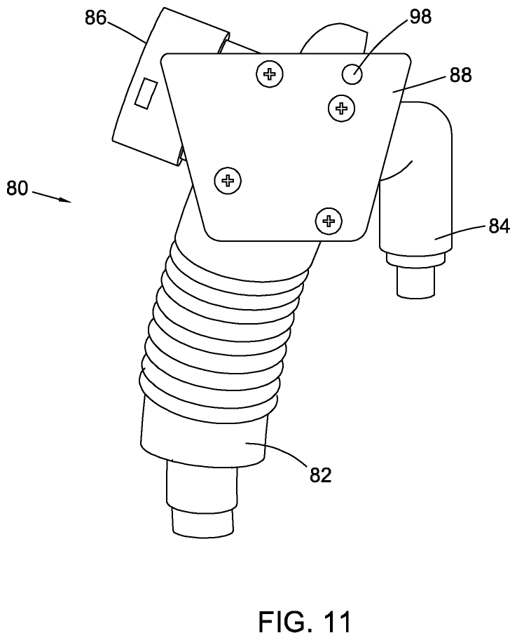

The L-shaped linear members 37A and 37B are inclined in opposite directions along the front surface 35 so that the upper ends when mounted (and as viewed in FIGS. 4 and 5) are further apart from each other than the lower ends (as viewed in FIGS. 4 and 5). The oppositely inclined channels 39A and 39B formed by the L-shaped linear members 37A and 37B are positioned to accommodate a tapered plate on the back of a CRU (Crew Regulator Unit)—described below in relation to FIG. 11.

The mounting plate 33 and main front surface 35 have an optional circular opening 42 in the centre, between the L-shaped linear members 37A and 37B.

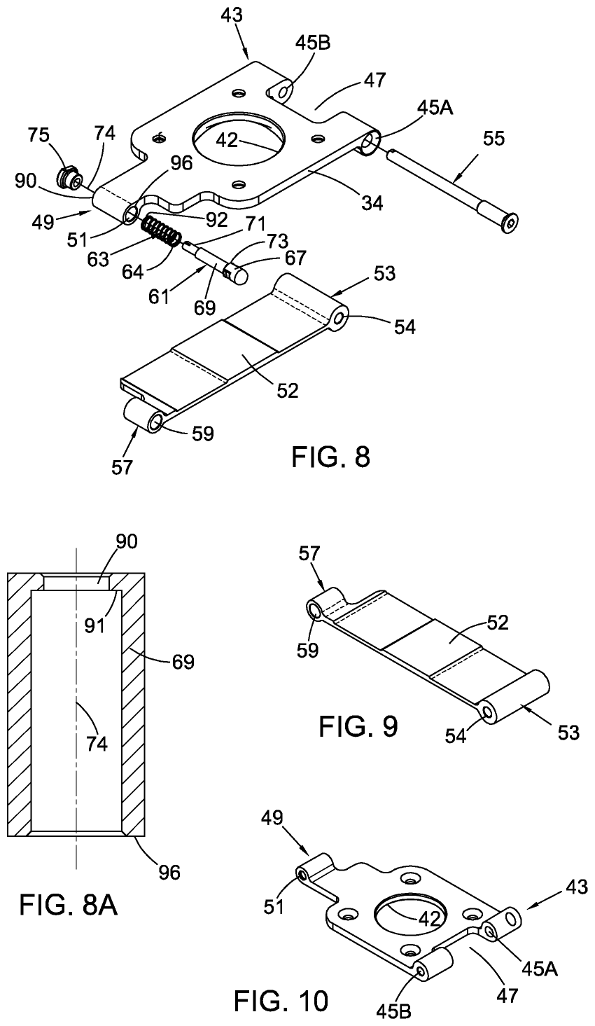

The mounting plate 33 includes a first connecting portion 43 that extends from the bottom (as viewed in FIGS. 4 and 5) of the central area 34. The first connecting portion 43 includes two tubular pivot portions 45A and 45B with a central space 47 therebetween, as best shown in FIG. 8.

The mounting plate 33 further includes a first locking portion 49 that extends from the top (as viewed in FIGS. 4 and 5) of the central area 34. The first locking portion 49 includes a first tubular locking part 51.

The mounting arrangement 31 further comprises a backing plate 52 having a generally rectangular shape and extending underneath (as viewed in FIGS. 4 and 5) and substantially parallel to the mounting plate 33 when the mounting arrangement 31 is in a closed position.

The backing plate 52 includes a second connecting portion 53 that extends from the bottom (as viewed in FIGS. 4 and 5). The second connecting portion 53 includes a central tubular pivot portion 54 which fits in the central space 47 between the two tubular pivot portions 45A and 45B of the first connecting portion 43 of the mounting plate 33.

A pivot pin 55 extends through central tubular pivot portion 54 and the two tubular pivot portions 45A and 45B. The pivot pin 55 couples the mounting plate 31 to the backing plate 52 and enables relative rotation between the mounting plate 31 and the backing plate 52 around the pivot pin 55. The pivot pin 55 may be secured in position, e.g. by peening its ends.

The backing plate 52 further includes a second locking portion 57 at the top (as viewed in FIGS. 4 and 5) of the backing plate 52. The second locking portion 57 includes a second tubular locking part 59.

A locking pin 61 passes through the first tubular locking part 51 and the second tubular locking part 59 prevent rotation between the mounting plate 33 and the backing plate 52 around the pivot pin 55 in the closed position.

As shown in FIG. 8, the locking pin 61 has a distal end 67 with a larger diameter than its mid-section 69. A proximal end 71 of the locking pin 61 has a smaller diameter than the mid-section 69. A compression spring 63 is positioned over the mid-section 69 so that a first end 64 thereof abuts a first shoulder 73 formed between the mid-section 69 and the distal end 67 of the locking pin 61.

As shown in FIG. 8A, which is a cross-section taken along the central axis 74 of the first tubular locking part 51, the outer end 90 of the first tubular locking part 51 has a relatively reduced internal diameter compared to the internal diameter of the rest of the first tubular locking part 51. The relatively reduced internal diameter outer end 90 forms a second shoulder 91 that is abutted by a second end 92 of the compression spring 63.

The locking pin 61, with the compression spring 63 positioned over the mid-section 69 thereof, with the first end 64 abutting the first shoulder 73 formed between the mid-section 69 and the distal end 67 of the locking pin 61, is then located in the first tubular locking part 51. As the locking pin 61 is pushed further into the first tubular locking part 51, the second shoulder 91 formed by relatively reduced internal diameter outer end 90 is abutted by a second end 92 of the compression spring 63 and the proximal end 71 of the locking pin 61 may emerge from the relatively reduced internal diameter outer end 90. A locking pin knob 75 is then fixed to the proximal end 71 of the locking pin 61, e.g. by peening or by proving each with cooperating screw treads.

The compression spring 63 is fitted between the locking pin 61 and first tubular locking part 51 so that, in its natural or rest state when no external force is applied, the compression spring 63 urges the locking pin 61 into the second tubular locking part 59 for locking the mounting plate 33 and the backing plate 52 in the closed position.

The locking pin 61 is configured to be manually moveable along axis 74, relative to the mounting plate 33 and the backing plate 52, so that the locking pin 61 withdraws from the second tubular locking part 59 to enable the mounting arrangement 31 to move into the open position. Manual movement of the locking pin is by pulling the locking pin knob 75.

The mounting arrangement 31 is fixed to an item worn by an aircrew member by putting the mounting arrangement in the open position and positioning the backing plate 52 behind and the item worn by the aircrew member. The front plate 33 is then rotated about the pivot pin 55 so that it overlies the item worn by an aircrew member and the backing plate 52 (so that the item worn by an aircrew member is between the front plate 33 and the backing plate 52).

The locking pin 61 is then manually moved along axis 74 against the force of the compression spring 63 so that the distal end 67 of the locking pin 61 moves into the inner end 96 of the first tubular locking part 51. This allows the second tubular locking part 59 to be aligned with the first tubular locking part 51 in the closed position—as shown in FIGS. 4 and 5—when the front plate 33 and the backing plate 52 lie parallel to one another.

When the locking pin 61 is then manually released, the compression spring 63 urges the distal end 67 of the locking pin 61 into the second tubular locking part 59 for locking the mounting plate 33 and the backing plate 52 in the closed position, and clamping aircrew member therebetween. In the locked position the locking pin 61 extends along the first tubular locking part 51 and the second tubular locking part 59 so that the mounting plate 33 and the backing plate 52 cannot be rotated about the pivot pin 55.

As mentioned above, the oppositely inclined channels 39A and 39B formed by the L-shaped linear members 37A and 37B are positioned to accommodate a tapered plate on the back of a CRU (Crew Regulator Unit). FIG. 11 shows a CRU 80.

The CRU 80 is connected to an on-board oxygen (breathing gas) supply (not shown) within the aircraft and the oxygen supply is then fed to a breathing mask (also not shown) which the aircrew may wear when required.

A breathing gas inlet 82 is connected to the on-board oxygen (breathing gas) supply. The breathing gas inlet 82 may incorporate a standard Aircraft Supply Quick-Disconnect with restrictor valve and spring-loaded relief valve installed. An emergency oxygen inlet 84 may also be provided.

A breathing gas outlet port 86 supplies breathing gas to the mask and may interface with the standard male three-pin connector found on the mask supply hose.

A flight vest outlet port may supply gas to an aircrew vest bladder during Pressure Breathing for G (PBG) and may also incorporate an integral pressure relief valve which relieves pressure when the vest supply hose is not connected.

The CRU 80 needs to be mounted onto an item worn by the aircrew member such that when the aircrew member enters the aircraft and is seated they can connect to the oxygen supply and put on the mask. The CRU 80 includes a tapered plate 88 on the back of the CRU slides into the inclined channels 39A and 39B formed by the L-shaped linear members 37A and 37B of the mounting plate 33. The tapered plate 88 has the shape of an isosceles trapezoid (a trapezoid having two parallel sides with two non-parallel legs of equal length extending therebetween).

The CRU 80 is locked to the mounting plate 33 by a spring-loaded pin 98 sliding along reducing depth V-shaped channel 94 in the mounting surface 35 and then, under the force of the spring, the pin 98 entering an opening 93 in the mounting surface 35 below the V-shaped channel 94. The CRU 80 may be release by manually pulling a release knob (not shown) to compress the spring of the spring-loaded pin 98 and disengage the pin 98 from the opening 93, whereafter the tapered plate 88 can slide out from between the L-shaped linear members 37A and 37B.

The item worn by an aircrew member may be a harness, a lifejacket or part of a load-carrying garment.

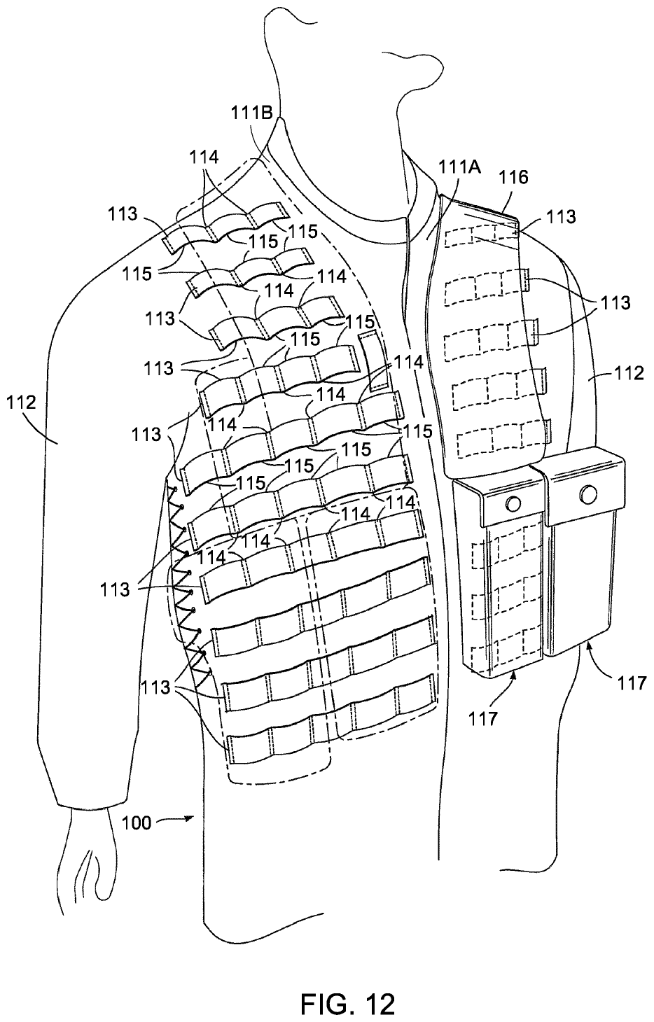

Referring first to FIG. 12 an example load-carrying garment 100 such as a military jacket has left and right front panels 111A, 111B overlying the chest of a wearer and meeting at the centre of the chest, and arms 112 for receiving the arms of a wearer. The left and right front panels 111A, 111B are both provided with rows of webbing 113. The rows 113 are parallel to but spaced from one another and, when the jacket is worn and the wearer upright, the rows are horizontal. The webbing may be arranged in accordance with the MOLLE (Modular Lightweight Load-carrying Equipment) specification (see, e.g. https://en.wikipedia.org/wiki/MOLLE). The MOLLE specification defines the current generation of load-bearing equipment and backpacks used by a number of NATO armed forces, especially the British Army and the United States Army.

Garments of this kind are disclosed in, for example, US2007/0158380, US2006/0113344, WO2006/116952 and US2008/0257922.

The webbing may be a MACS system (Modular Attachment Carrier System), available from Survitec Group Ltd.

Each row is formed by a single length of webbing 113 that is woven in known fashion from cotton or artificial fibres or a mixture of both and has a width of about 25 mm (although any suitable flexible material may be used). Each length of webbing 113 is stitched (or otherwise connected) to the associated panel 111A, 111B at its ends and at equidistant intervals between its ends along stitch lines 114, each stitch line 114 creating an attachment section. The spacing between the stitch lines 114 is about 38 mm. Each webbing 113 length thus forms a succession of attached portions and unattached loops 115 along its length. The loops 115 formed by one row are vertically aligned with the loops of the next adjacent rows.

The function of the loops 115 is to allow the attachment to the garment of various loads; these may include a packed inflatable lifejacket 116 and equipment packs 117.

The webbing rows 113 are shown and described as extending horizontally when the wearer is upright. While this is preferred, this need not be the case. The rows could have any desired orientation relative to the wearer.

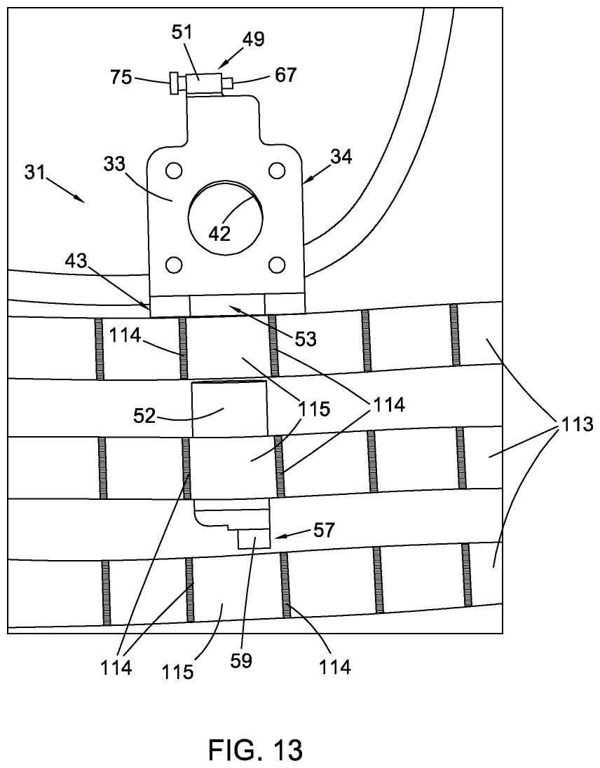

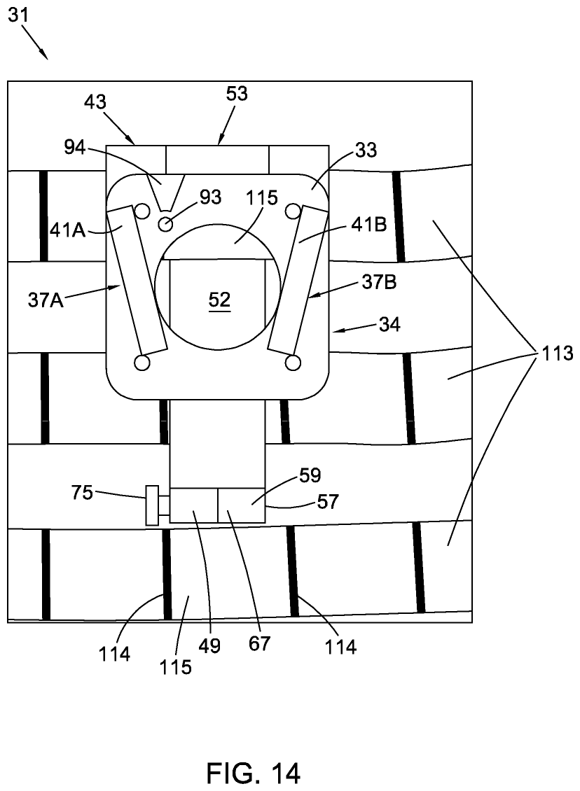

The mounting arrangement 31 may be fitted to a loop 115 of a webbing row 113, as shown in FIGS. 13 and 14. The mounting arrangement 31 is fixed to the loop 115 by putting the mounting arrangement 31 in the open position and positioning the backing plate 52 behind and the loop 115, as shown in FIG. 13. The front plate 33 is then rotated about the pivot pin 55 so that it overlies the loop 115 and the backing plate 52 (so that the loop 115 is between the front plate 33 and the backing plate 52), as shown in FIG. 14.

The locking pin 61 is then manually moved against the force of the compression spring 63 so that the locking pin 61 withdraws into the first tubular locking part 51. This allows the second tubular locking part 59 to be aligned with the first tubular locking part 51 in the closed position—as shown in FIGS. 4 and 5.

When the locking pin 61 is then manually released, the compression spring 63 urges the locking pin 61 into the second tubular locking part 59 for locking the mounting plate 33 and the backing plate 52 in the closed position, and clamping the loop 115 therebetween.

It should be noted that the mounting surface 35 shown in FIG. 14 has the opposite orientation of that shown in FIGS. 4 and 5. That is, the first and second connecting portions 43, 53 are at the top of the mounting assembly 31 and the first and second locking portions 49, 57 are at the bottom of the mounting assembly 31. The L-shaped linear members 37A and 37B are inclined in opposite directions along the front surface 35 so that the upper ends when mounted (as viewed in FIG. 14) are further apart from each other than the lower ends (as viewed in FIG. 14). Either orientation of the mounting plate 33 may be used, according to the circumstances.

Although the members 37A and 37B forming the channels 39A and 39B are linear in the embodiments described, it should be appreciated that other shapes may be used according to the circumstances—and depending on the shape of the plate 88 of the aircrew safety equipment, which may not be a trapezoid.

Although in the embodiments described the locking pin 61 is housed in the mounting plate 33 for engaging the backing plate 52 in the closed position, this may be reversed—and the locking pin may be housed in the backing plate for engaging the mounting plate in the closed position.

The hole 42 in the mounting plate 33 may be omitted or may have a different shape to that shown. A hole may be provided in the main surface of the backing plate 52.

1. An aircrew safety equipment mounting arrangement for attachment to an item worn on the body of an aircrew member, the mounting arrangement including a mounting plate, a backing plate, a pivotal attachment coupling the mounting plate to the backing plate, and a lock configured to lock the mounting plate and the backing plate in a closed position, the mounting arrangement being moveable by the pivotal attachment between the closed position, in which the mounting arrangement is arranged to clamp the item worn on the body of an aircrew member between the mounting plate and the backing plate, and an open position in which the item worn on the body of an aircrew member is released.

2. The mounting arrangement of claim 1, wherein the mounting plate includes a mounting plate tubular pivot portion and the backing plate includes a backing plate tubular pivot portion, and wherein the pivotal attachment comprises a pivot pin that passes through the mounting plate tubular pivot portion and the backing plate tubular pivot portion to enable relative rotation between the mounting plate and the backing plate around the pivot pin.

3. The mounting arrangement of claim 1, wherein the mounting plate includes a mounting plate tubular locking portion and the backing plate includes a backing plate tubular locking portion, and wherein the lock comprises a locking pin that is configured to pass through the mounting plate tubular locking portion and the backing plate tubular locking portion to prevent rotation between the mounting plate and the backing plate around the pivot pin.

4. The mounting arrangement of claim 3, wherein the lock further comprises a compression spring fitted between the locking pin and tubular locking portion of one of the mounting plate and the backing plate so that the compression spring urges the locking pin into the tubular locking portion of the other of the mounting plate and the backing plate for locking the mounting plate and the backing plate in the closed position.

5. The mounting arrangement of claim 4, wherein the locking pin is configured to be manually moveable relative to the mounting plate and the backing plate so that the locking pin withdraws from the tubular locking portion of the other of the mounting plate and the backing plate to enable the mounting arrangement to move into the open position.

6. The mounting arrangement of claim 2, wherein the mounting plate tubular pivot portion and the backing plate tubular pivot portion are at an opposite end of the mounting arrangement to the mounting plate tubular locking portion and the backing plate tubular locking portion.

7. The mounting arrangement of claim 1, wherein the mounting plate includes at least one formation configured to mechanically engage aircrew safety equipment to couple the aircrew safety equipment to the item worn on the body of an aircrew member.

8. The mounting arrangement of claim 7, wherein the least one formation comprises two oppositely inclined channels configured to engage a tapered connecting plate of the aircrew safety equipment.

9. The mounting arrangement of claim 1, wherein the aircrew safety equipment comprises a crew regulator unit.

10. The mounting arrangement of claim 1, wherein the item worn on the body of the aircrew member includes a strip of material to which the mounting arrangement is arranged to clamp when closed in use.

11. The mounting arrangement of claim 1, wherein the item worn on the body of the aircrew member includes a part of a harness, lifejacket or a load-carrying garment.

12. The mounting arrangement of claim 11, wherein the load-carrying garment is a MOLLE load-carrying garment comprising at least one row of webbing that is attached to a backing at attachment sections at spaced apart intervals.

13. A method of facilitating attachment aircrew safety equipment to an item worn on the body of an aircrew member, the method including:
providing a mounting arrangement including a mounting plate, a backing plate, a pivotal attachment coupling the mounting plate to the backing plate, and a lock configured to lock the mounting plate and the backing plate in a closed position;
when the mounting arrangement is in an open position, passing the backing plate behind the item worn on the body of an aircrew member;
rotating the mounting plate about the pivotal attachment to the closed position, in which the mounting arrangement clamps the item worn on the body of an aircrew member between the mounting plate and the backing plate; and
locking the mounting plate to the backing plate in a closed position.

14. The method of claim 13, including mechanically attaching the aircrew safety equipment to the mounting arrangement to couple the aircrew safety equipment to the item worn on the body of an aircrew member to thereby locate the aircrew safety equipment on the body of the aircrew member.

15. The method of claim 13, wherein the mounting arrangement is as claimed in claim 1.

16. An aircrew safety equipment mounting arrangement for attachment to an item worn on the body of an aircrew member, the mounting arrangement including a mounting plate, a backing plate, pivotal attachment means for coupling the mounting plate to the backing plate, and locking means for locking the mounting plate and the backing plate in a closed position, the mounting arrangement being moveable by the pivotal attachment means between the closed position, in which the mounting arrangement is arranged to clamp the item worn on the body of an aircrew member between the mounting plate and the backing plate, and an open position in which the item worn on the body of an aircrew member is released.

17. The mounting arrangement of claim 16, wherein the mounting plate includes a mounting plate tubular pivot portion and the backing plate includes a backing plate tubular pivot portion, and wherein the pivotal attachment means comprises a pivot pin that passes through the mounting plate tubular pivot portion and the backing plate tubular pivot portion to enable relative rotation between the mounting plate and the backing plate around the pivot pin.

18. The mounting arrangement of claim 16, wherein the mounting plate includes a mounting plate tubular locking portion and the backing plate includes a backing plate tubular locking portion, and wherein the locking means comprises a locking pin that is configured to pass through the mounting plate tubular locking portion and the backing plate tubular locking portion to prevent rotation between the mounting plate and the backing plate around the pivot pin.

19. The mounting arrangement of claim 18, wherein the locking means further comprises a compression spring fitted between the locking pin and tubular locking portion of one of the mounting plate and the backing plate so that the compression spring urges the locking pin into the tubular locking portion of the other of the mounting plate and the backing plate for locking the mounting plate and the backing plate in the closed position.

20. The mounting arrangement of claim 19, wherein the locking pin is configured to be manually moveable relative to the mounting plate and the backing plate so that the locking pin withdraws from the tubular locking portion of the other of the mounting plate and the backing plate to enable the mounting arrangement to move into the open position.
